(19) United States
(12) Patent Application Publication
(10) Pub. No.: US 2021/0001751 A1
(43) Pub. Date: Jan. 7, 2021

(54) THERMOREGULATION SYSTEM AND ELECTRICALLY DRIVEN VEHICLE COMPRISING SUCH A SYSTEM

(71) Applicant: VOLVO TRUCK CORPORATION, Göteborg (SE)

(72) Inventor: Ronan MOTHIER, Dizimieu (FR)

(73) Assignee: VOLVO TRUCK CORPORATION, Göteborg (SE)

(21) Appl. No.: 16/970,433

(22) PCT Filed: Mar. 28, 2018
(86) PCT No.: PCT/EP2018/057948

§ 371 Date: Aug. 17, 2020

(51) Int. Cl. B60L 58/24; B60L 58/26; B60L 58/27; B60L 50/60; B60H 1/00; H01M 2/10; H01M 10/613; H01M 10/625; H01M 10/6568; H01M 10/6552

(52) U.S. Cl. CPC B60L 58/24; B60L 58/26; B60L 58/27; B60L 50/60; B60H 1/00278; H01M 2220/20; H01M 10/613; H01M 10/625; H01M 10/6568; H01M 10/6552; B60H 1/00385; H01M 2/1077

(57) ABSTRACT

This thermoregulation system (1) is for an electrically driven vehicle (V), the vehicle comprising at least one battery (30). The thermoregulation system (1) comprises a coolant circuit (5) in which circulates a coolant, a pump (7) for circulating the coolant, and a at least one battery exchanger (11), connected to the coolant circuit (5) so that the coolant may circulate through the battery exchanger (11), and configured for exchanging heat between the coolant and said at least one battery (30). The coolant circuit (5) comprises a bypass line (41) allowing isolation of the battery exchanger (11) from the coolant circuit (5).

The present invention concerns a thermoregulation system for an electrically driven vehicle. The invention also concerns an electrically driven vehicle comprising such a thermoregulation system.

Batteries used for full electric vehicles, hybrid electric vehicles, or fuel cells electric vehicles require complex thermal management with a coolant circuit in order to ensure vehicle mobility, performances, lifetime, etc. Depending on the circumstances, batteries need to be cooled down, heated up, or temperature homogenized. For example, the batteries may be able to work under temperatures comprised between 20° C. and 35° C. to ensure correct chemical operation, optimal lifetime and mechanical resistance. All these functionalities must be ensured in a very efficient way in order to avoid negative impact on the performances of the vehicles.

Usually the way to ensure battery heat up or thermal homogenization is to let coolant circulating in the whole coolant circuit. This means that much more coolant than required is flowing. Heating up the complete vehicle might be necessary to ensure that the batteries are at their required temperature. This leads to an energy waste that negatively impacts the overall vehicle performances.

The aim of the invention is to provide an improved thermoregulation system, in which the temperature of one or several batteries is controlled with a better cost and performance efficiency.

To this end, the invention concerns a thermoregulation system for an electrically driven vehicle, the vehicle comprising at least one battery, the thermoregulation system comprising:
a coolant circuit in which circulates a coolant,
a pump for circulating the coolant,
a at least one battery exchanger, connected to the coolant circuit so that the coolant may circulate through the battery exchanger, and configured for exchanging heat between the coolant and said at least one battery.

This thermoregulation system is characterized in that the coolant circuit comprises a bypass line allowing isolation of the battery exchanger from the coolant circuit.

Thanks to the invention, the energy waste in case the batteries have a specific thermal need is avoided, and the main coolant circuit can go on working as usual during the specific need phase of the batteries.

According to further aspects of the invention which are advantageous but not compulsory, such a thermoregulation system may incorporate one or several of the following features:
The thermoregulation system comprises several battery exchangers configured for exchanging heat between the coolant and several batteries of the vehicle, said several battery exchangers being interconnected by a battery coolant loop connected to the coolant circuit, and adapted to be isolated from the coolant circuit by the bypass line.
The battery exchangers are grouped in parallel.
The thermoregulation system comprises at least two groups of battery exchangers in parallel.
The thermoregulation system comprises a pump for running coolant circulation in the at least one battery exchanger when the at least one battery exchanger is isolated from the coolant circuit.
The thermoregulation system comprises a heating device adapted to heat up the coolant circulating in the at least one battery exchanger.
The thermoregulation system comprises at least one control unit adapted to control various working parameters of the thermoregulation system.
The at least one control unit is adapted to control at least one of:
   a valve allowing coolant circulation in the bypass line,
   a pump of the thermoregulation system for running coolant circulation in the at least one battery exchanger when the at least one battery exchanger is isolated from the coolant circuit,
   a heating device of the thermoregulation system adapted to heat up the coolant circulating in the at least one battery exchanger.

The invention also concerns an electrically driven vehicle comprising at least one battery, wherein it comprises a thermoregulation system as mentioned here-above.

The invention will now be explained in reference to the annexed drawings, as an illustrative example. In the annexed drawings:

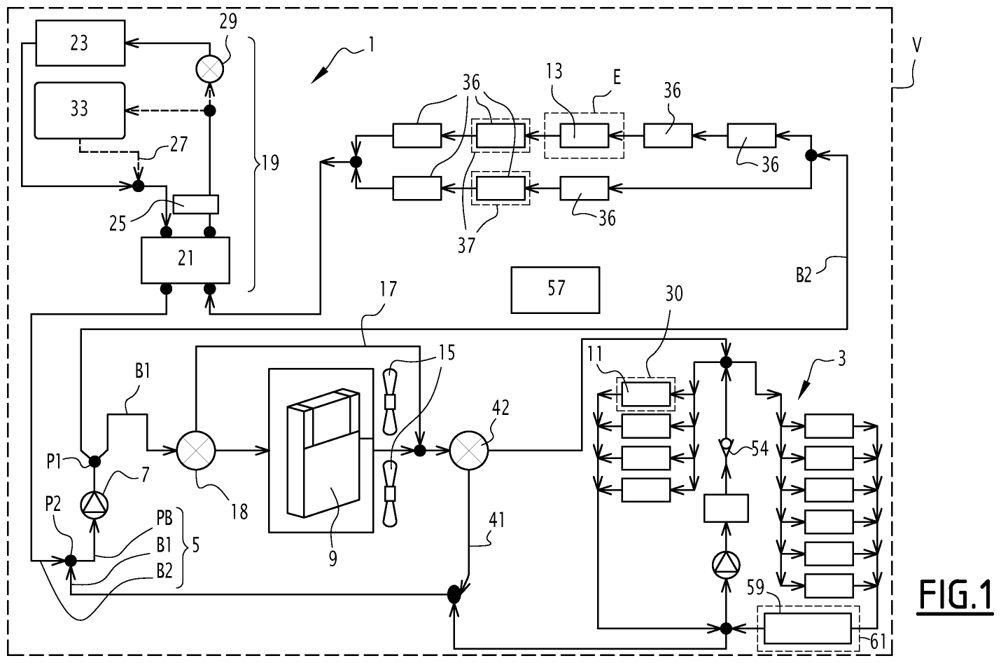

FIG. 1 is a schematic view of a thermoregulation system according to the invention, integrated in a vehicle according to the invention;

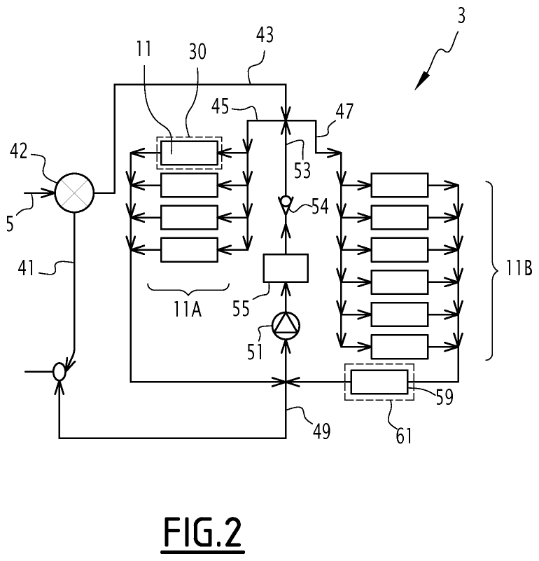

FIG. 2 is a detailed view of a battery system of the thermoregulation system of FIG. 1.

FIG. 1 represents a thermoregulation system 1 installed on an electrically driven vehicle V, such as a truck. The electrically driven vehicle V may be a hybrid vehicle, including also a non-shown internal combustion engine or at least one fuel cell, or a full-electric vehicle.

The vehicle V comprises at least one electric machine E, and a battery system 3 for storing electrical energy for powering the electric machine E. The battery system 3 is formed by a plurality of batteries 30. More generally, the vehicle V comprises at least one battery 30.

The thermoregulation system 1 comprises a coolant circuit 5 in which a coolant circulates, under action of a pump 7. The thermoregulation system 1 comprises coolant heat exchangers, connected to the coolant circuit 5 so that the coolant may circulate through them. The exchangers comprise a main exchanger 9, configured for exchanging heat between the coolant and air coming from the outside of the vehicle V. For example, the main exchanger 9 may be formed by at least one radiator. In the main exchanger, the coolant gets cooled down giving the heat to the exterior air flow.

The exchangers also comprise a plurality of battery exchangers 11, each configured for exchanging heat between the coolant and one of the batteries 30 of the battery system 3. In case the vehicle V comprises only one battery 30, the thermoregulation system 1 comprises only one battery exchanger 11. Only one battery 30 is represented in dotted lines around a battery exchanger 11 for the sake of clarity of the drawings.

The exchangers also comprise a secondary exchanger 13, configured for exchanging heat between the coolant and the electric machine E. The electric machine E is represented in dotted lines around the secondary exchanger 13.

The coolant circuit 5 is divided in:
a first branch B1, called low-temperature branch, which comprises the main exchanger 9 and the battery exchangers 11,
a second branch B2, called high-temperature branch, which comprises the secondary exchanger 13.
a pump branch PB to which the pump 7 is connected.

The coolant circulates in parallel in the two branches B1 and B2. The pump branch PB is connected to the first and second branch B1 and B2 by an upstream connection point P1 and by a downstream connection point P2, so that the coolant circulating in the pump branch PB is formed by a mix of the coolant circulating in the first branch B1 and of the coolant circulating in the second branch B2, and is directed towards the first and second branches B1 and B2 downstream the pump 7.

Due to the fact that the first branch B1 comprises the main exchanger 9, the temperature of the coolant of the first branch B1 is lower than the temperature of the coolant in the second branch B2. This allows cooling down the batteries 30 to a lower temperature than the electrical engine E, which can work at higher temperatures.

In an embodiment, the primary exchanger 9 is located upstream the battery exchangers 11. In other words, the battery exchangers 11 are located at the coldest area of the coolant circuit 5. This guarantees the optimized operation of the thermoregulation system 1 and that the batteries 30 work in their required temperature interval.

According to an optional embodiment, the main exchanger 9 is equipped with at least one fan, for example two fans 15, accelerating air passage in the main exchanger 9. This allows cooling down the coolant to a lower temperature after circulation in the main exchanger 9.

According to an optional embodiment, the coolant circuit 5 comprises a bypass line 17 allowing deactivation or reduction of coolant circulation in the main exchanger 9. The coolant can be derived into the bypass line 17 using a valve 18 connected on the first branch B1. Such a feature allows deactivation or reduction of thermal exchange between the coolant and exterior air in the event the coolant is already at a low enough temperature.

According to an embodiment, the second branch B2 is connected to a heating system 19 for a driver cabin. In order to benefit from the heating of the coolant that results from the passage in the secondary exchanger 13, the heating system 19 may be located downstream the secondary exchanger 13.

The heating system 19 may be connected to the coolant circuit 5 via a pressure valve 21. The heating system 19 may comprise a heat exchanger 23, adapted to exchange heat with a conditioned air flow circulating in the driver's cabin. As an optional embodiment, an electrical heating device 25 may be connected to the heating system 19 upstream from the heating exchanger 23, in order to heat up the coolant in case the temperature of the coolant is too far from a requested temperature.

The thermoregulation system comprises an expansion tank 33, that is located in the heating system 19, but could be provided at any place of the system as long as it is the highest point of the circuit. The expansion tank 33 absorbs coolant expansion due to temperature and ensures a continuous coolant de-aeration. The expansion tanks 33 is provided in a line 27 parallel to the heating exchanger 23, and a valve 29 controls the distribution of fluid flows in the line 27 and in the heating exchanger 23.

The second branch B2 may also be connected to at least one supplemental exchanger configured for exchanging heat between the coolant and at least one supplemental electrical device of the vehicle V. In the present case, the thermoregulation system 1 comprise several other exchangers 36 that are coupled to various other electrical equipment placed upstream or downstream the electric machine E, such as electrical inverters 37, or transmissions, or auxiliaries (for example air compressors), amongst others. At least some of these supplementary exchangers 36 may be installed in parallel with the secondary exchanger 13 or with other supplementary exchangers 36. Electrical components that have the most critical working temperature intervals are placed at the most upstream position. The electrical components mentioned here-above and the electric machine E have a working temperature between 40° C. and 65° C., and are less sensitive to high temperatures than the batteries 30.

The coolant circuit 5 comprises a bypass line 41 allowing isolation of the battery exchangers 11 from the coolant circuit 5. The coolant is derived in the bypass line 41 using a valve 42. In such a case, a cooling down of the batteries 30 at a too low temperature is prevented. In case the batteries 30 need to be heated up, the isolation from the coolant circuit 5 prevents the whole coolant circuit 5 to be heated up. This results in better performances and lower energetic cost.

As shown on FIG. 2, the battery system 3 comprises several battery exchangers 11 interconnected by a battery coolant loop 43 connected to the coolant circuit 5, and adapted to be isolated from the coolant circuit 5 by the bypass line 41. The battery coolant loop 43 distributes the coolant in the battery exchangers 11 when the battery coolant loop 43 is connected to the coolant circuit 5.

In an embodiment, the battery exchangers 11 are grouped in parallel. The coolant circulates in parallel in the battery exchangers 11, allowing a homogenization of the temperatures of the batteries 30.

According to an optional embodiment, the thermoregulation system 1 may comprise two groups 11A and 11B of battery exchangers 11 in parallel. For example, the group 11A comprises four battery exchangers 11 in parallel, and the group 11B comprises six battery exchangers 11 in parallel. The groups 11A and 11B are themselves disposed in parallel. The battery coolant loop 43 may separate in two lines 45 and 47 downstream the valve 42, and the lines 45 and 47 are reunited downstream the groups 11A and 11B in a line 49 that rejoins the coolant circuit 5 downstream the bypass line 41. In the present case, both groups 11A and 11B can be isolated from the coolant circuit 5.

More generally, the thermoregulation system 1 comprises at least one group of battery exchangers in parallel.

In an embodiment, the thermoregulation system 1 comprises a pump 51 for running coolant circulation in the battery exchangers 11 when the battery exchangers 11 are isolated from the coolant circuit 5. This pump 51 is connected on a line 53 which links the loop 43 and the line 49 and connects the lines 45 and 47 to form two loops. The line 53 comprises a check valve 54 which prevents coolant flow through lines 53 and pump 51 when the battery system 3 is connected to the main coolant circuit 5.

The pump 51 runs a coolant circulation in closed loop in the groups 11A and 11B. After circulation in the exchangers 11, the coolant passes in the line 53 and goes back to the upstream side of the lines 45 and 47 to circulate again in the battery exchangers 11.

In the case the thermoregulation system 1 comprises only one battery exchanger 11, the pump 51 runs coolant circulation in this single battery exchanger 11.

In an embodiment, the thermoregulation system 1 comprises a heating device 55 adapted to heat up the coolant circulating in the battery exchangers 11. The heating device 55 is for example an electrical device and is connected on the line 53 downstream the pump 51. This allows heating up the batteries 30 in case these batteries 30 are at a too low temperature with respect to the required working temperatures of the batteries 30.

As an optional embodiment, the first branch B1 may also include a heat exchanger 59, configured for exchanging heat with at least one low temperature power electronics component 61 of the electrical vehicle V. Such a component 61 may require a low working temperature interval similar to the low working temperatures of the batteries 30. The heat exchanger 59 may be connected to the first branch B1 downstream or upstream the battery exchangers 11 depending on temperature requirements. In the example, the heat exchanger 59 may be able to be isolated from the cooling circuit 5 using the bypass line 41. As a non-shown variant, the heat exchanger 59 may not be able to be isolated from the cooling circuit 5 using the bypass line 41.

The thermoregulation system 1 may comprise at least one control unit, for example one control unit 57, adapted to control various working parameters of the thermoregulation system 1. The control unit 57 may receive working parameters and data from sensors arranged at various places of the coolant circuit 5, such as coolant temperature, temperatures of batteries 30, of the electric machine E, for example. The control unit 57 may send control signals to the various components of the thermoregulation system 1, for example valves, pumps, heaters, or fans. The control unit 57 may be equipped with a communication device adapted to receive and emit signals, with wired or wireless communications means.

For example, the control unit 57 may be adapted to control the operation of the pump 7 to regulate the coolant flow in the coolant circuit 5.

For example, the control unit 57 may be adapted to control the valve 18, to partially or totally bypass the main exchanger 9, in case the coolant temperature is already cold enough.

For example, the control unit 57 may be adapted to control the valve 42, to bypass the battery exchangers 11, in case the coolant temperature is too cold.

For example, the control unit 57 may be adapted to control the operation of the pump 51 to initiate coolant circulation in the battery exchangers 11 while the battery system 3 is isolated from the coolant circuit 5.

For example, the control unit 57 may be adapted to activate or deactivate heating by the heating device 55 depending on special heating needs of the batteries 30.

For example, the control unit 57 may be adapted to activate or deactivate the fans 15 if a special cooling need is detected in the coolant circuit 5.

For example, the control unit 57 may be adapted to activate or deactivate the heating device 25, depending on the conditioned air temperature requests in the driver's cabin. The thermoregulation system 1 can be applied to various electrically driven vehicles, such as trucks, buses, trailers, utility automotive vehicles, cars, or any land vehicle.

The features of the embodiments and variants described here-above can be combined to form new embodiments of the invention.

1. A thermoregulation system for an electrically driven vehicle the vehicle comprising at least one battery, the thermoregulation system comprising:
a coolant circuit in which circulates a coolant,
a pump for circulating the coolant,
a at least one battery exchanger, connected to the coolant circuit so that the coolant may circulate through the battery exchanger, and configured for exchanging heat between the coolant and said at least one battery,
wherein the coolant circuit comprises a bypass line allowing isolation of the battery exchanger from the coolant circuit.

2. A thermoregulation system according to claim 1, wherein the thermoregulation system comprises several battery exchangers configured for exchanging heat between the coolant and several batteries of the vehicle, said several battery exchangers being interconnected by a battery coolant loop connected to the coolant circuit, and adapted to be isolated from the coolant circuit by the bypass line.

3. A thermoregulation system according to claim 2, wherein the battery exchangers are grouped in parallel.

4. A thermoregulation system according to claim 3, wherein the thermoregulation system comprises at least one group of battery exchangers in parallel.

5. A thermoregulation system according to claim 1, wherein the thermoregulation system comprises a pump for running coolant circulation in the at least one battery exchanger when the at least one battery exchanger is isolated from the coolant circuit.

6. A thermoregulation system according to claim 1, wherein the thermoregulation system comprises a heating device adapted to heat up the coolant circulating in the at least one battery exchanger.

7. A thermoregulation system according to claim 1, wherein the thermoregulation system comprises at least one control unit adapted to control various working parameters of the thermoregulation system.

8. A thermoregulation system according to claim 7, wherein said at least one control unit is adapted to control at least one of:
a valve allowing coolant circulation in the bypass line,
a pump of the thermoregulation system for running coolant circulation in the at least one battery exchanger when the at least one battery exchanger is isolated from the coolant circuit,
a heating device of the thermoregulation system adapted to heat up the coolant circulating in the at least one battery exchanger.

9. An electrically driven vehicle comprising at least one battery, wherein it comprises a thermoregulation system according to claim 1.
